(19) United States
(12) Patent Application Publication
(10) Pub. No.: US 2026/0118268 A1
(43) Pub. Date: Apr. 30, 2026

(54) ELECTRONIC ARRANGEMENT AND METHOD FOR DETERMINING A PHOTOCURRENT TAKING INTO ACCOUNT A TEMPERATURE DEPENDENCE, AND ALSO AN OPTICAL GAS SENSOR

(71) Applicant: E+E Elektronik Ges.m.b.H., Engerwitzdorf (AT)

(72) Inventors: Markus Humer, Wels (AT); Marcus Hintermüller, Leonding (AT); Albin Haider, Alberndorf (AT); Michael Weilguni, Gallneukirchen (AT)

(21) Appl. No.: 19/366,545

(22) Filed: Oct. 23, 2025

(30) Foreign Application Priority Data
Oct. 25, 2024 (DE) 102024131188.6

(51) Int. Cl. G01N 21/61

(52) U.S. Cl. CPC G01N 21/61

(57) ABSTRACT

An electronic arrangement for determining a photocurrent taking into account a temperature dependence, including a photodetector which has an anode connection and a cathode connection, an operational amplifier, a bias voltage connection, and a voltage divider. The operational amplifier has a first input, a second input and an output. The anode connection of the photodetector and the first input of the operational amplifier are electrically connected to one another, and the cathode connection of the photodetector and the second input of the operational amplifier are electrically connected to one another. The bias voltage connection is electrically connected to the anode connection of the photodetector and the first input of the operational amplifier via a first path. The voltage divider is arranged within the first path between the anode connection of the photodetector and the bias voltage connection.

### CROSS REFERENCE TO RELATED APPLICATIONS

This application claims benefit to German Patent Application No. DE102024131188.6, filed on Oct. 25, 2024, which is hereby incorporated by reference herein.

### FIELD

The invention relates to an electronic arrangement and a method for determining a photocurrent taking into account a temperature dependence and to an optical gas sensor having the electronic arrangement.

### BACKGROUND

It is known from the prior art to use photodetectors, for example photodiodes made of InSb or InAsSb for optical gas sensors. In addition to measuring the radiation of light not absorbed by a gas (and determining therefrom, for example, the carbon dioxide content of the gas), this type of photodetector also renders it possible to determine the extent to which the respective photodetector's own temperature influences the radiation measurement. This determination is required in order to compensate the temperature dependence of the respective radiation measurement.

EP 3 581 898 A1 describes an electronic arrangement which comprises a photodiode and a transimpedance amplifier and can be selectively switched between a photocurrent measurement mode and a temperature measurement mode. In the photocurrent measurement mode, an anode connection of the photodiode is connected to a first input of an operational amplifier of the transimpedance amplifier, a cathode connection of the photodiode is connected to a second input of the operational amplifier, and a first bias voltage connection is connected to the first input and the anode connection. In the temperature measurement mode, the anode connection is connected to an earth connection of the electronic arrangement, the cathode connection is connected to the second input, and the first bias voltage connection is connected to the first input and isolated from the anode connection.

In order to be able to switch between the photocurrent measurement mode and the temperature measurement mode, the electronic arrangement disclosed in EP 3 581 898 A1 comprises three switches. In the photocurrent measurement mode, two of the three switches are closed, so that no voltage is applied to the photodiode and it is therefore operated in quasi-short-circuit mode. Only when radiation is detected is a photocurrent generated in the photodiode, which is amplified by the transimpedance amplifier and converted into a voltage. In the temperature measurement mode, the two previously closed switches are open and only the third switch is closed, so that a bias voltage drops across the photodiode, causing a temperature-dependent (reverse) current to flow even without the detection of radiation. This current is amplified with a reduced gain factor. The reduced amplification is necessary here because the voltage applied to the bias voltage connection is typically in the range of 150 to 200 mV. Lower values cannot usually be set directly. Therefore, the amplification must be reduced accordingly so that the current after amplification is within a detectable range that can be digitized, for example, by means of an analogue-to-digital converter.

However, implementing multiple switches to actively switch between the different measurement modes carries the risk of sources of error, for example due to defects and/or wear effects. Therefore, there is still a need for an improved solution, in particular a simplified electronic arrangement that is capable of determining a photocurrent, taking into account a temperature dependence, with at least a reduced number of possible sources of error.

### SUMMARY

In an embodiment, the present disclosure provides an electronic arrangement for determining a photocurrent taking into account a temperature dependence, comprising a photodetector which has an anode connection and a cathode connection, an operational amplifier, a bias voltage connection, and a voltage divider. The operational amplifier has a first input, a second input and an output. The anode connection of the photodetector and the first input of the operational amplifier are electrically connected to one another, and the cathode connection of the photodetector and the second input of the operational amplifier are electrically connected to one another. The bias voltage connection is electrically connected to the anode connection of the photodetector and the first input of the operational amplifier via a first path. The voltage divider is arranged within the first path between the anode connection of the photodetector and the bias voltage connection.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an electronic arrangement in accordance with an embodiment of the present disclosure in a schematic plan view;

FIG. 2 illustrates a gas sensor with the electronic arrangement in accordance with an embodiment of the present disclosure in a schematic plan view;

FIG. 3 illustrates a procedural sequence of a method in accordance with an embodiment of the present disclosure;

FIG. 4 illustrates an exemplary progression of an output voltage during the course of a method according to an embodiment of the present disclosure;

FIG. 5 illustrates exemplary progressions of a (reversing) current flowing through the photodetector of the electronic arrangement in dependence on a temperature of the photodetector in the case of different bias voltages;

FIG. 6 illustrates exemplary progressions of “quasi”-signals of the photodetector in dependence on a bias voltage of the photodetector, and

FIG. 7 illustrates exemplary progressions of the output voltages in dependence on a temperature of the photodetector.

### DETAILED DESCRIPTION

In an embodiment, the present disclosure provides an improved, in particular simplified, electronic arrangement for determining a photocurrent, by means of which disadvantages of known solutions are preferably at least partially avoided, wherein, for example, a most accurate and reliable determination of a photocurrent possible is still guaranteed, taking into account a temperature dependence of a photodetector.

In a first general aspect of the present disclosure, an electronic arrangement is provided for determining a photocurrent taking into account a temperature dependence.

The electronic arrangement comprises a photodetector which has an anode connection and a cathode connection.

The electronic arrangement comprises an (in particular voltage-controlled) operational amplifier which has a first input, a second input and an output. The anode connection of the photo detector and the first input of the operational amplified are electrically connected to one another (for example via a second path). The cathode connection of the photodetector and the second input of the operational amplifier are electrically connected to one another.

The electronic arrangement comprises a bias voltage connection which is electrically connected to the anode connection of the photodetector and the first input of the operational amplifier via a first path.

The electronic arrangement comprises a voltage divider which is arranged within the first path between the anode connection of the photodetector and the bias voltage connection.

A photodetector, also referred to as an optical detector and/or a light sensor, is understood to mean within the scope of this disclosure an electronic component which converts radiation based on the internal photoelectrical effect into an electrical signal. This electrical signal is also referred to as a photocurrent and/or photosignal. The photodetector is thus a radiation-measuring component, wherein the radiation can be not only a visible light but rather also infrared radiation and ultraviolet radiation. For example, the photodetector can be a photodiode, i.e. a semiconductor diode, which converts radiation at a p-n junction or pin junction based on the internal photoelectric effect into an electric current, i.e. a photocurrent.

Numerous application possibilities for detecting radiation occurring at the photodetector are provided for the photodetector. For example, the photodetector or the electronic arrangement can be used in order to determine a gas content of a specific gas, for example carbon dioxide, in the environment of the photodetector. For this purpose, a radiation source can be activated and radiation emitted in the direction of the photodetector, wherein a gas to be examined is located between the radiation source and the photodetector. The gas content, for example the gas concentration, can be determined with the aid of the intensity of the radiation detected by the photodetector (i.e. the generated photocurrent) in relation to an expected intensity of the radiation (i.e. an expected photo current), wherein the portion of the radiation which does not reach the photodetector is absorbed or deflected from the gas. Therefore, the electronic arrangement can be designed, for example, as part of a gas sensor.

Regardless of the irradiation of the photodetector, a (reverse) current flowing through the photodetector can be generated by applying a bias voltage. In the present case, this bias voltage is generated by a voltage provided at the bias voltage connection via the first path. This (reverse) current or bias voltage is temperature-dependent and can thus be used to determine the influence of temperature on the photodetector or on currents flowing through the photodetector. This occurs, for example, by providing a voltage at the bias voltage connection and measuring an output voltage of the photodetector, without the photodetector itself detecting a radiation or the photodetector is not irradiated.

Within the scope of this disclosure, the operational amplifier is understood to mean a direct voltage-coupled amplifier with a, for example, very high gain factor. The operational amplifier is thus an electronic component that records a difference between two input voltages and outputs this difference amplified as an output voltage in relation to a reference potential or earth. Accordingly, the inputs of the operational amplifier are, for example, high ohmic and the output of the operational amplifier low ohmic.

In the present case, the first input voltage is applied at the first input of the operational amplifier via the bias voltage connection and the second input voltage is applied at the second input of the operational amplifier via the photodetector. As a result, the operational amplifier is configured in particular so as to provide an output voltage which depends on the input voltage provided via the photodetector and amplifies this by the gain factor. As a result, for example, a photocurrent generated by the irradiation of the photodetector can be amplified accordingly and can be detected at the output of the operational amplifier by means of a current and/or voltage measuring device.

The voltage divider is to be understood within the scope of this disclosure to be an electrical component which is configured in order to generate at least one output voltage which is a fraction of an input voltage of the voltage divider. In this case, the voltage divider can divide an input voltage into multiple voltage parts which can be tapped as output voltages at the voltage divider (or at outputs of the voltage divider).

For example, the voltage divider can be realized by a series connection of two or more resistors, wherein a voltage part can be tapped between the resistors. In the present case, the voltage divider is configured in particular in an expedient manner in order to generate and provide a bias voltage of the photodetector (as an output voltage of the voltage divider), the bias voltage being a fraction or a voltage part of a voltage applied at the bias voltage connection (as an input voltage of the voltage divider).

A path, for example the first path, can be understood within the scope of the disclosure to be any suitable electrical connection or any suitable electrical conductor between two or more connections. A path can therefore also be referred to as an electrical connection and/or electrical conductor. A path can have several sub-paths, wherein respectively at least one electrical component can be arranged between two of the multiple sub-paths, for example the voltage divider within the first path.

A resistor is to be understood within the scope of the disclosure to be an electronic component which has a preferably unchangeable ohmic resistance.

The above-described electronic arrangement in accordance with the present disclosure offers a number of advantages. Thus, the implementation of the voltage divider renders it possible in the same measurement mode to determine a photocurrent, which is generated when the photodetector is irradiated, and a (reverse) current (also: quiescent current), which can be determined in order to investigate the temperature dependence of the photodetector when a bias voltage is applied without irradiating the photodetector. It is thus made possible to perform a combined measurement of temperature and photocurrent in a common measurement mode, so that a switch is not required.

During the development of embodiments of the present disclosure, it was encouragingly and surprisingly discovered that the temperature dependence of photodetectors of different detector types is qualitatively not dependent on the applied bias voltage, i.e. the temperature behaviour of the reverse current is qualitatively not dependent on the applied (bias) voltage. Furthermore, especially at low bias voltages, the photodetectors behave like ohmic resistors and are therefore linear, i.e. the (reverse) current flowing through the respective photodetector is essentially linear to the bias voltage. Nonlinearities due to the special design of the photodetectors (for example, in the form of steps or jumps in the progressions) only occur at higher bias voltages above 10 V, especially in the range of 12 V.

Furthermore, it was encouragingly and surprisingly discovered that the photocurrent is not dependent on an applied bias voltage, at least when the bias voltage is within a sufficiently low voltage range (depending, inter alia, on other things, on the respective detector type of the photodetector). In other words, a generated reverse current has no qualitative influence on a photocurrent generated by the detection of radiation based on the internal photoelectric effect, at least in the case of a low bias voltage (for example, below 2 mV).

This means that measurements of a photocurrent and measurements to investigate temperature dependence can be performed by means of the (reverse) current in the case of the same bias voltage, as long as this bias voltage is within a sufficiently low voltage range (for example, below 2 mV).

Such a sufficient reduction of the input voltage which is applied at the bias voltage connection and which provides the bias voltage at the photodetector via the first path is guaranteed in accordance with the present disclosure by the voltage divider. This renders it possible to perform the measurements of the photocurrent and the (reverse) current in the case of the same bias voltage. It is thus no longer necessary to switch the electronic arrangement between different measurement modes, in particular to switch to a quasi-short circuit in order to measure the photocurrent, as occurs in the previously described prior art.

Accordingly, the electronic arrangement does not have any switching elements. The omission of switching elements is not only helpful when developing the measurement principle, for example in an integrated circuit, but also leads to a small installation space, lower component and manufacturing costs, and a reduced number of sources of error.

In accordance with an embodiment, the anode connection of the photodetector, the first input of the operational amplifier and the bias voltage connection are connected to one another fixedly and/or without switches, i.e. in particular without switching elements between the anode connection of the photodetector, the first input of the operational amplifier, and the bias voltage connection and/or without switching elements within the first path.

As previously mentioned, due to the voltage divider, it is not necessary to switch the electronic arrangement between different measurement modes, so that it is also advantageous that it is not necessary to provide interruptions between electrical connections and thus the switching elements required for this within the first path or even in the entire electronic arrangement.

In accordance with an embodiment, the voltage divider is configured in order to provide a bias voltage of the photodetector when a voltage is applied at the bias voltage connection. The bias voltage can have a value of 2 mV or less, in particular 1 mV or less. Alternatively, or additionally, the bias voltage can be at least 100 times, in particular at least 200 times, lower than the voltage applied at the bias voltage connection. Consequently, the voltage divider is configured in an advantageous manner in order to reduce the applied input voltage to a bias voltage in a desired value or value range, wherein, for example, conventional current and/or voltage sources can be used to provide the input voltage and conventional photodetectors for switching the electronic arrangement.

The voltage applied at the bias voltage connection can have a value of 500 mV or less, for example 200 mV. It is thus made possible in an advantageous manner, for example, to use conventional current and/or voltage sources to provide a voltage at the bias voltage connection.

In accordance with an embodiment, the bias voltage connection is also electrically connected to the cathode connection of the photodetector and to the second input of the operational amplifier.

In accordance with an embodiment, the second input of the operational amplifier is configured as an inverting input of the operational amplifier. The inverting input can be designed in order to adapt and/or to regulate a potential at the second input of the operational amplifier, for example, at least approximately to a value of a potential applied at the first input of the operational amplifier. As a result, a virtual earth can be generated at the second input of the operational amplifier. Alternatively, or additionally, the operational amplifier can be designed as part of a transimpedance amplifier. In other words, the electronic arrangement can have a transimpedance amplifier which has the operational amplifier.

In accordance with an embodiment, the electrical arrangement also comprises a negative feedback path which electrically connects the second input of the operational amplifier and the output of the operational amplifier to one another. The negative feedback path can run parallel to the operational amplifier. The negative feedback path can have a resistor, in particular two resistors connected in series.

In accordance with an embodiment, the electrical arrangement also comprises a branch path which electrically connects the negative feedback path in a region between the two resistors connected in series of the negative feedback path and the bias voltage connection to one another. It is also provided that the branch path has a branch resistor.

The branch path and optionally the negative feedback path can be configured without switches, i.e. in particular without switching elements within the branch path and optionally the negative feedback path.

The transimpedance amplifier can have the operational amplifier, the negative feedback path and the branch path. The transimpedance amplifier can have the two resistors connected in series of the negative feedback path and/or the branch resistor of the branch path.

The negative feedback path and optionally the branch path, in particular the two resistors connected in series of the negative feedback path and optionally the branch resistor, render it possible in an advantageous manner to set a desired, high gain factor of the operational amplifier or of the transimpedance amplifier.

The operational amplifier and/or the transimpedance amplifier can have a gain factor of at least 100·10⁶Ω, for example at least 200·10⁶Ω. The gain factor can be unchangeable.

The gain factor can depend on and/or be set by resistance values of the two resistors connected in series of the negative feedback path and/or of the branch resistor of the branch path. As a result, it is provided in an advantageous manner to ensure that the current forwarded by the photodetector, i.e. a photocurrent and/or (reverse) current, is amplified in the desired manner so that, for example, measurements can be made within a desired voltage range. Furthermore, the option to keep the gain factor unchanged can advantageously result in a simplified design of the operational amplifier or transimpedance amplifier, wherein, for example, no switching elements are necessary to change the gain factor.

The operational amplifier and/or the transimpedance amplifier can be configured to convert a current forwarded by the photodetector, for example a photocurrent generated by the photodetector, into a current with a voltage of at least 1 V, for example approximately 2 V or more. The operational amplifier and/or the transimpedance amplifier can also be configured to convert the current forwarded by the photodetector into a current with a voltage of a maximum 5 V, for example 3 V or less. As a result, the measured current can be amplified in an advantageous manner and converted into a voltage which can be measured by conventional current and/or voltage measuring devices, wherein the converted voltage can lie, for example, in a voltage range which can be digitized by an analogue-to-digital converter.

The photodetector can be configured in order to generate a photocurrent with a current strength of up to 50 nA, in particular up to 20 nA. By way of example, it is thus advantageously made possible to use conventional photodetectors, for example, semi-conductor detectors or photodiodes, for example, for the electronic arrangement.

In accordance with an embodiment, the electronic arrangement also comprises a capacitor which is arranged parallel to the resistor, in particular to the two resistors connected in series of the negative feedback path, to form a low-pass filter.

In accordance with an embodiment, the voltage divider has an input, a first output and a second output. The input of the voltage divider can be electrically connected to the bias voltage connection. The first output of the voltage divider can be electrically connected to the anode connection of the photodetector. It is provided that the voltage provided at the first output of the voltage divider can be at least 100 times, in particular at least 200 times, lower than the voltage applied at the input of the voltage divider. The voltage divider can consequently be able to advantageously provide a bias voltage in a desired value or value range via the first output.

In accordance with an embodiment, the voltage divider has a first resistor and a second resistor. The first resistor can be arranged between the input of the voltage divider and the first output of the voltage divider. The first resistor and the second resistor can be arranged between the input of the voltage divider and the second output of the voltage divider.

In accordance with an embodiment, the electronic arrangement also comprises an earth connection which is electrically connected to the anode connection of the photodetector and the bias voltage connection. For example, the second output of the voltage divider can be electrically connected to the earth connection.

In accordance with an embodiment, it is made possible in dependence, for example, linearly and/or proportionally on a current applied at the photodetector and/or generated in the photodetector to determine and/or tap an output voltage between the output of the operational amplifier and the bias voltage connection. The output voltage can depend linearly and/or proportionally on a photocurrent and/or a (reverse) current, for example. This advantageously allows conclusions to be drawn about radiation detected by the photodetector and a temperature dependence of the photodetector by determining output voltages.

It is provided for a current and/or voltage measuring device, for example, an analogue-to-digital converter and/or a microcontroller, to be connected or be connected at the output of the operational amplifier and optionally the bias voltage connection. The electronic arrangement can have the current and/or voltage measuring device, for example, for measuring an output current and/or an output voltage of the electronic arrangement.

It is provided for a current and/or voltage source to be connected or be connected at the bias voltage connection. The electronic arrangement can comprise the current and/or voltage source. For example, it is provided for a voltage provided by the current and/or voltage source to be set or controlled via a voltage regulator and/or microcontroller.

In accordance with an embodiment, the photodetector can be a photodiode. The photodetector and/or the photodiode can be made at least in part of indium antimonide (abbreviated: InSb) and/or indium arsenide antimonide (abbreviated: InAsSb).

In accordance with a general aspect of the present disclosure, an optical gas sensor is provided. The optical gas sensor can be configured to optically detect a gas, for example, carbon dioxide, in particular to determine a gas content, for example a gas concentration, of a gas.

The optical gas sensor comprises a measuring cell for receiving a gas.

The optical gas sensor comprises a radiation source for emitting radiation in the direction of the measuring cell. For example, the radiation source can be an infrared radiation source for emitting infrared radiation, in particular radiation in the mid-infrared range. Infrared radiation can be used in particular advantageously for determining a gas content, for example a gas concentration, if the gas is carbon dioxide, since carbon dioxide absorbs infrared light of specific wave lengths.

The optical gas sensor comprises an electronic arrangement as disclosed herein. The photodetector of the electronic arrangement is arranged to detect at least part of the radiation that has passed through the measuring cell and the gas contained in the measuring cell.

Thus, the electronic arrangement disclosed herein can be advantageously used for the optical detection of a gas located in the measuring cell. The optical detection can be carried out in a simple manner by means of the optical gas sensor by detecting the radiation by means of the photodetector and measuring or evaluating the output voltages of the electronic arrangement, wherein, for example, the gas content or gas concentration of the gas can be determined.

In accordance with an embodiment, the measuring cell can be arranged at least in sections between the radiation source and the photodetector of the electronic arrangement, and/or between the radiation source and the electronic arrangement.

The measuring cell can have at least one outer opening for the gas to enter from an environment of the optical gas sensor.

In accordance with a general aspect of the present disclosure, a method for determining a photocurrent taking into account a temperature dependence is provided.

The method is performed by means of an electronic arrangement as disclosed herein and/or an optical gas sensor as disclosed herein.

The method comprises providing a bias voltage of the photodetector by applying a voltage at the bias voltage connection.

The method comprises determining a first output voltage of the electrical arrangement and/or the optical gas sensor when a bias voltage is applied. The photodetector is not irradiated by radiation and/or a radiation source for emitting radiation, for example the radiation source of the optical gas sensor, is deactivated.

The method comprises determining a second output voltage of the electrical arrangement and/or the optical gas sensor when a bias voltage is applied. The photodetector is irradiated by radiation and/or the radiation source is activated.

Thus, the electronic arrangement and the optical gas sensor as disclosed herein can be advantageously used to determine a photocurrent taking into account a temperature dependence without requiring changes to configurations or measurement modes of the electronic arrangement. Instead, it is sufficient to perform measurements without irradiating the photodetector and with irradiating the photodetector. To this end, deactivating and then activating (or conversely) a radiation source can be sufficient to determine the first output voltage, which depends solely on a (reverse) current generated by an applied bias voltage, and the second output voltage, which depends on the (reverse) current and the photocurrent generated by the detected radiation.

In accordance with an embodiment, the method can be performed by means of the optical gas sensor, wherein a gas content, for example a gas concentration of a gas, can be determined within the measuring cell from a difference between the second output voltage and the first output voltage.

The difference can depend linearly and/or proportionally on a photocurrent of the photodetector and consequently on radiation and/or radiation intensity detected by the photodetector. It is thus advantageously made possible solely with the aid of the determined output voltages to draw conclusions about a gas in the environment of the photodetector or the electronic arrangement, i.e. within the measuring cell. It is thus made possible to detect a gas optically in a simple manner by means of the optical gas sensor, wherein the gas content or the gas concentration can be determined by simply determining the difference between determined output voltages.

According to an embodiment, a beginning of the provision of the bias voltage, in particular before the determination of the first output voltage of the second output voltage, can represent a switch-on phase, wherein the low-pass filter formed by the capacitor causes an in particular slow time constant.

The first output voltage can depend, for example linearly and/or proportionally, on a (reverse) current of the photodetector. The second output voltage can depend, for example linearly and/or proportionally, on a sum of a photocurrent and a (reverse) current of the photodetector.

The first output voltage and the second output voltage can be determined sequentially within less than two seconds, in particular less than one second.

The first output voltage and the second output voltage can be determined and/or tapped between the output of the operational amplifier and the bias voltage connection.

In order to avoid repetition, features previously disclosed purely in relation to the device (with regard to the electronic arrangement and/or the optical gas sensor) shall also be deemed to be disclosed in relation to the method, and vice versa.

The previously described embodiments and features of the present disclosure can be combined with one another as desired. Further features and advantages of embodiments of the present disclosure arise from the description below and from the attached drawings, to which reference is made.

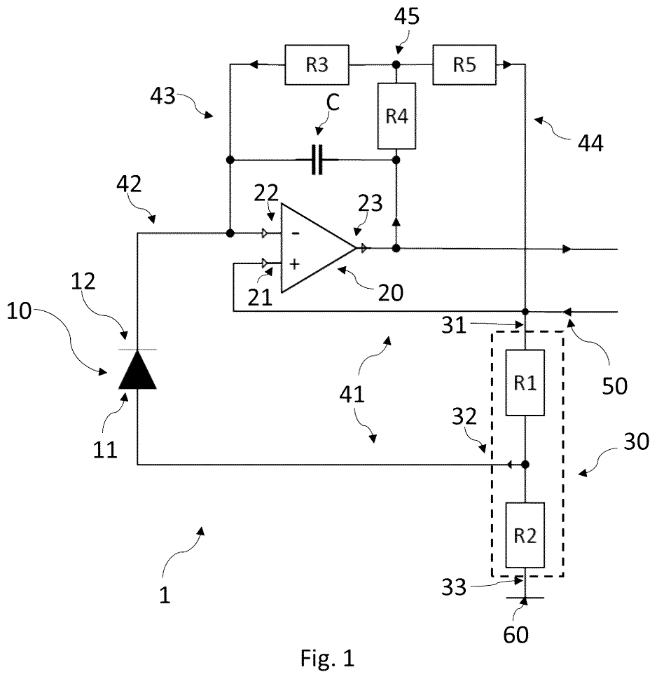

FIG. 1 shows schematically an electronic arrangement 1 for determining a photocurrent taking into account a temperature dependence in accordance with an embodiment of the present disclosure.

The electronic arrangement 1 comprises a photodetector 10 which has an anode connection 11 and a cathode connection 12. The photodetector 10 can be expediently designed as a photodiode and can be, for example, a semiconductor detector which is made at least in part of InSb and/or InAsSb. As a result, the photodetector 10 can be configured in order to detect in particular infrared light.

The electronic arrangement 1 comprises an operational amplifier 20 which has a first input 21, a second input 22 and an output 23. The second input 22 can be designed, for example, as an inverting input of the operational amplifier 20.

The operational amplifier 20 and the photodetector 10 are expediently electrically connected to one another. For this purpose, it is provided that the anode connection 11 of the photodetector 10 and the first input 21 of the operational amplifier 20 are electrically connected to one another via a first path 41, and the cathode connection 12 of the photodetector 10 and the second input 22 of the operational amplifier 20 are electrically connected to one another via a second path 42.

The electronic arrangement 1 also comprises a bias voltage connection 50 which is electrically connected to the anode connection 11 of the photodetector 10 and the first input 21 of the operational amplifier 20 via the first path 41 so as to apply an input voltage.

The voltage divider 30 is configured in order to provide a bias voltage of the photodetector 10 when a voltage is applied at the bias voltage connection 50. This allows a (reverse) current to flow through the photodetector 10 even without irradiation of the photodetector 10.

The bias voltage can have a value of 2 mV or less, in particular 1 mV or less, and/or be at least 100 times, in particular at least 200 times, lower than the voltage applied to the bias voltage connection 50. Thus, the bias voltage connection 50, for example, can be supplied with an electric current by a conventional current and/or voltage source, wherein this electric current can have a voltage of 500 mV or less, for example in a range from 150 mV to 200 mV.

The electronic arrangement 1 further comprises a voltage divider 30, which is arranged within the first path 41 between the anode connection 11 of the photodetector 10 and the bias voltage connection 50. The voltage divider 30 serves to reduce or divide the input voltage applied at the bias voltage connection 50 along the path 41 in the direction of the photodetector 10 to the desired bias voltage.

In the illustrated embodiment, the voltage divider 30 has an input 31, a first output 32 and a second output 33. The input 31 of the voltage divider 30 is electrically connected to the bias voltage connection 50 and the first output 32 of the voltage divider 30 is electrically connected to the anode connection 11 of the photodetector 10. The voltage applied at the first output 32 of the voltage divider 30 is, for example, at least 100 times, in particular at least 200 times, lower than the voltage applied at the input 31 of the voltage divider 30.

The voltage divider 30 has a first resistor R1 and a second resistor R2. The first resistor R1 is arranged between the input 31 of the voltage divider 30 and the first output 32 of the voltage divider 30 and the first resistor R1 and the second resistor R2 are arranged between the input 31 of the voltage divider 30 and the second output 33 of the voltage divider 30.

The electronic arrangement 1 also comprises an earth connection 60 which is electrically connected to the anode connection 11 of the photodetector 10 and the bias voltage connection 50, wherein the second output 33 of the voltage divider 30 is electrically connected to the earth connection 60.

The operational amplifier 20 is in particular a voltage-controlled operational amplifier and is designed as part of a transimpedance amplifier. Accordingly, the electrical arrangement 1 or the transimpedance amplifier comprises a feedback coupling in the form of a negative feedback path 43 which electrically connects the second input 22 of the operational amplifier 20 and the output 23 of the operational amplifier 20 to one another. This negative feedback path 43 has as a resistance two resistors R3, R4 connected in series.

Furthermore, the electrical arrangement 1 or the transimpedance amplifier also comprises a branch path 44 which electrically connects the negative feedback path 43 in a region 45 between the two resistors R3, R4 connected in series and the bias voltage connection 50 to one another. The branch path 44 has a branch resistor R5.

Thus, the bias voltage connection 50 is not only electrically connected to the anode connection 11 of the photodetector 10 and the first input 21 of the operational amplifier 20 but is also electrically connected via the negative feedback path 43 and the branch path 44 to the cathode connection 12 of the photodetector 10 and the second input 22 of the operational amplifier 20.

In so doing, the negative feedback path 43 and the branch path 44 are expediently configured without switches, i.e. in particular no switching elements are provided in the negative feedback path 43 and in the branch path 44, so that fixed electrical connections are provided.

The negative feedback path 43 and the branch path 44, including the resistors R3, R4 and R5, form together with the operational amplifier 20 the transimpedance amplifier. This transimpedance amplifier can have a gain factor G of at least 100·10⁶Ω, for example 200·10⁶Ω or higher, wherein the gain factor depends on the resistance values of resistors R3, R4 and R5:

$$G = {R}_{3} \cdot ( 1 + \frac{{R}_{4}}{{R}_{5}} ) + {R}_{4} .$$

In the illustrated embodiment, the electronic arrangement 1 also comprises a capacitor C which is arranged parallel to the two resistors R3, R4 connected in series of the negative feedback path 43, to form a low-pass filter.

Consequently, in comparison to the prior art disclosed in EP 3 581 898 A1, the embodiment illustrated in FIG. 1 of the electronic arrangement 1 in particular does not have any switching elements. In lieu of two switching elements which are used in EP 3 581 898 A1, in order in the photocurrent measurement mode to connect an anode connection of a photo diode selectively to a first input of an operational amplifier and to a first bias voltage connection and in the temperature measurement mode to an earth connection, the electronic arrangement 1 in accordance with the present disclosure comprises the voltage divider 30. The voltage divider 30 is accordingly not configured in order to selectively isolate or switch over the electrical connection to the anode connection 11 of the photodetector 10 but ensures that a constantly sufficient low bias voltage of the photodetector 10 can be provided via the bias voltage connection 50.

Moreover, in lieu of a switching element that is used in EP 3 581 898 A1 in order in the photocurrent measurement mode to selectively connect a negative feedback path to a second bias voltage connection and in the temperature measurement mode to isolate it from the second bias voltage connection, the negative feedback path 43 and the branch path 44 of the electronic arrangement 1 in accordance with the present disclosure are designed without switches.

In this case, in particular the branch path 44 is fixedly connected to the bias voltage connection 50 so that an unchangeable gain factor of the operational amplifier 20 or the transimpedance amplifier is provided, while the gain factor of the transimpedance amplifier in EP 3 581 898 A1 is reduced in the temperature measurement mode by the electrical isolation of the negative feedback path and the second bias voltage connection.

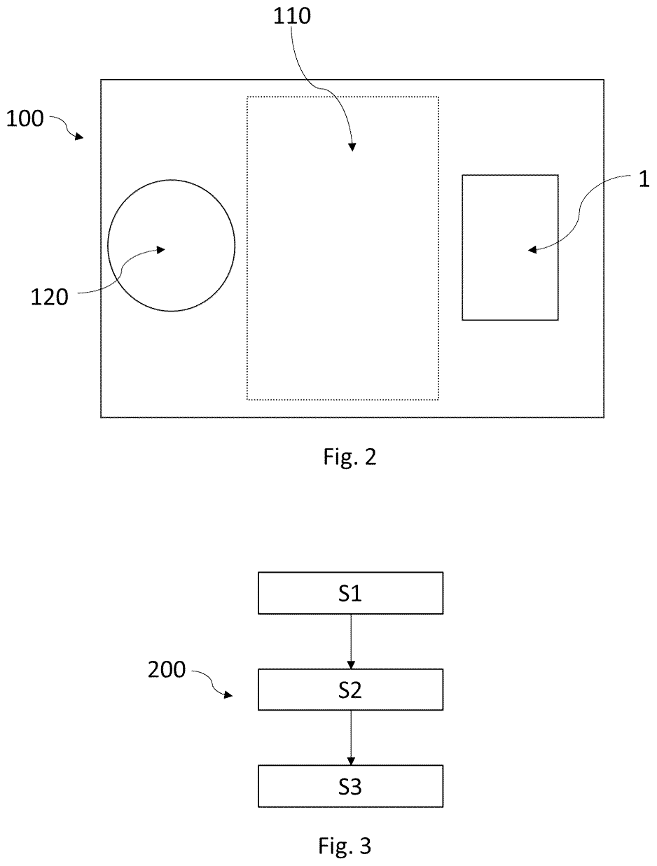

FIG. 2 shows schematically an optical gas sensor 100 in accordance with an embodiment, wherein the optical gas sensor 100 comprises the electronic arrangement 1.

The optical gas sensor 100 also comprises a measuring cell 110 for receiving a gas. The measuring cell 110 can have, for example, at least one outer opening for the gas to enter from an environment of the optical gas sensor 100.

The optical gas sensor 100 also comprises a radiation source 120 for emitting radiation in the direction of the measuring cell 110. In particular, the radiation source 120 can be an infrared radiation source for emitting infrared radiation, in particular radiation in the mid-infrared range.

The photodetector 10 of the electronic arrangement 1 is arranged to detect at least one part of the radiation which has passed through the measuring cell 110, wherein the measuring cell 110 can be arranged, for example at least in sections, between the radiation source 120 and the photodetector 10 or the electronic arrangement 1.

In this manner, the optical gas sensor 100 can be configured in an expedient manner to optically detect the gas (for example carbon dioxide) in the measuring cell 110. In particular, it is made possible with the aid of detecting the at least one part of the radiation which has passed through the measuring cell 110 and the gas to determine a gas content, for example a gas concentration, of the gas in the measuring cell 110, wherein the detectable intensity of the radiation which reaches the photodetector 10 and is not absorbed and/or reflected by the gas in the measuring cell 110 depends on the type of gas and the gas content.

Thus, the radiation detected by the photodetector 10 generates a photocurrent based on the internal photoelectric effect, the level and current strength of which depend on the radiation intensity of this detected radiation. The photocurrent can be tapped after amplification by the operational amplifier 20, for example, between the output 23 of the operational amplifier 20 and the bias voltage connection 50.

FIG. 3 represents an exemplary method 200 for determining a photocurrent taking into account a temperature dependence, wherein the method 200 can be performed in particular at least in part by means of the electronic arrangement 1 and/or the optical gas sensor 100.

In a first method step S1, a bias voltage of the photodetector 10 is provided by applying a voltage at the bias voltage connection 50.

The first method step S1 can represent a switch-on phase, wherein, for example, the low-pass filter formed by the capacitor C can cause a slow time constant right at the beginning of the method 200.

In a second method step S2, a first output voltage of the electrical arrangement 1 and/or the optical gas sensor 100 is determined when a bias voltage is applied, wherein the photodetector 10 is not irradiated by radiation and/or the radiation source 120 for emitting radiation is deactivated.

Consequently, in the second method step S2, no photocurrent is generated by detecting radiation. Instead, only a (reverse) current generated by the bias voltage flows through the photodetector 10. The first output voltage can depend accordingly, for example linearly and/or proportionally, on the (reverse) current of the photodetector 10.

In a third method step S3, a second output voltage of the electrical arrangement 1 and/or the optical gas sensor 100 is determined when a bias voltage is applied, wherein the photodetector 10 is irradiated by radiation and/or the radiation source 120 is activated.

The irradiation generates the photocurrent and thus an electrical signal in the order of magnitude of multiple nanoamperes, for example approximately 10 nA. The photocurrent (together with the (reverse) current) is forwarded via the second path 42 and amplified again by the operational amplifier 20 or the transimpedance amplifier with a high gain factor of, for example, 200·10⁶Ω and converted into a current with a voltage in the order of magnitude of, for example, approximately 2 V.

In the third method step S3, a sum of the generated photocurrent and the (reverse) current thus flows through the photodetector 10. The second output voltage depends accordingly, for example linearly, on a sum of the photocurrent and the (reverse) current of the photodetector 10.

The first output voltage and the second output voltage can be determined and/or tapped between the output 23 of the operational amplifier 20 and the bias voltage connection 50.

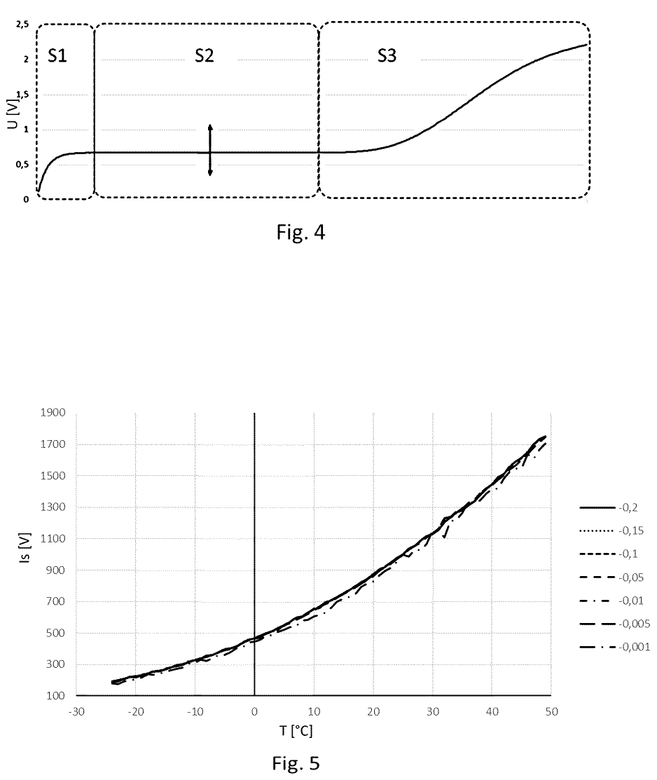

FIG. 4 shows an exemplary progression of an output voltage U during the course of the method 200. In the switch-on phase of the first method step S1, the output voltage U increases up to the first output voltage, i.e. the temperature-dependent (reverse) current, wherein from the start the high amplification by the operational amplifier 20 or the transimpedance is active and optionally the slow time constant is recognizable through the low-pass filter.

After the switch-on phase, the first output voltage can now be determined in the second method step S2, wherein the photodetector 10 is not irradiated or no radiation source is active.

Finally, the photodetector 10 is irradiated or a radiation source activated in the third method step S3, which leads to an increase in the output voltage U until another plateau is reached, namely the second output voltage.

In contrast to the prior art in EP 3 581 898 A1, it is thus not necessary to switch between the two method steps S2 and S3, between different measurement modes. In particular, it is not necessary in the third method step S3 to deactivate the bias voltage again and produce a quasi-short circuit of the photodetector 10.

It is thus made possible for switching elements to be omitted in the electronic arrangement 1. In particular, the anode connection 11, the first input 21 of the operational amplifier 20 and the bias voltage connection 50 can be electrically connected to one another fixedly and/or without switches. In other words, in particular no switching elements are provided within the first path 41 or between the anode connection 11, the first input 21 of the operational amplifier 20 and the bias voltage connection 50.

Furthermore, inter alia, the negative feedback path 43 and thus the negative feedback of the operational amplifier 20 or the transimpedance amplifier can be electrically connected in a fixed manner to the bias voltage connection 50 via the branch path 44, wherein the branch path 44 in particular can be designed without switches. Furthermore, it is provided that the entire electronic arrangement 1 can be designed without switches, i.e. without switching elements.

Instead, the two method steps S2 and S3 are performed one after the other in the same measurement mode, i.e. when the same bias voltage is applied. Also, in contrast to EP 3 581 898 A1 (in which the gain factor in temperature measurement mode is reduced by a factor of approximately 700 compared to the photocurrent mode), it is not necessary to change the gain factor using the operational amplifier 20 or the transimpedance amplifier, so that the gain factor can be unchangeable.

The necessary reduction of the voltage applied at the bias voltage connection 50 in order to provide a sufficiently low bias voltage of the photodetector 10 is guaranteed by the voltage divider 30.

The sufficiently low bias voltage which is, for example, in the range of up to 2 mV, can thus be achieved by suitably selecting the two resistors R1 and R2 of the voltage divider 30. Purely as an example, when a voltage of 200 mV is applied at the bias voltage connection 50, which is set or controlled by a conventional microcontroller, for example, a bias voltage of approximately 0.5 mV can be achieved by selecting R1=2.43 kOhm and R2=1 MOhm:

$$U = 200 mV \cdot ( \frac{{R}_{1}}{{R}_{1} + {R}_{2}} ) ∼ 0.5 mV .$$

Surprisingly, at such low bias voltages, the photodetector 10 behaves like an ohmic resistor, i.e. the voltage and current strength are essentially linearly dependent on each other. Nonlinearities due to the special construction of the photodetector 10 only occur in the case of higher voltages.

Moreover, the temperature dependence in these low voltage ranges is qualitatively independent of the applied voltage. In other words, the temperature-dependent (reverse) current of the photodetector 10 is essentially not dependent on the low bias voltage, so that reverse current progressions are essentially identical for different bias voltages in dependence on the temperature.

Thus, FIG. 5 shows exemplary progressions of a reverse current Is flowing through the photodetector 10 (normalized to 1000 at 25° C.) in dependence on the temperature T of the photodetector in the case of different bias voltages from 0.001 V (i.e. 1 mV) up to 0.2 V (i.e. 200 mV). As is apparent, the progressions are essentially identical and are consequently qualitatively not dependent upon the low bias voltages. Small fluctuations of the voltage applied at the bias voltage connection 50 and consequently of the bias voltage do not therefore have any significant influence on the temperature dependence. Consequently, the temperature measurement, i.e. the temperature-dependent (reverse) current (also: quiescent current) or the first output voltage dependent on the (reverse) current in the second method step S2 can be determined in the case of a low bias voltage.

Furthermore, the photocurrent Ip is at least in the low bias voltage range previously mentioned essentially not dependent on the applied bias voltage or the generated (reverse) current or this dependency is at least insignificant. In other words, low bias voltages have no or an insignificant influence on the level and the progression of the photocurrent Ip generated by the photodetector 10 when the photodetector 10 is irradiated.

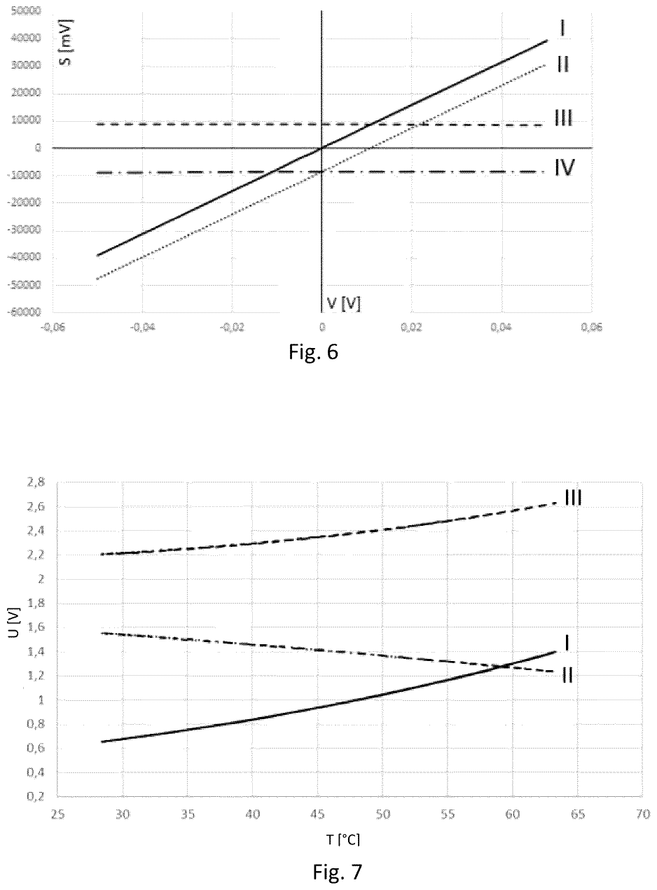

Thus, FIG. 6 shows exemplary progressions of “quasi”-signals S leaving the photodetector 10 during the two method steps S2 and S3, in dependence on the bias voltage V of the photodetector 10, wherein the determined output voltages of these “quasi”-signals S depend on the amplification by the operational amplifier 20. The progression I corresponds to the temperature-dependent (reverse) current through the photodetector 10 when a bias voltage is applied without irradiation of the photodetector 10, whereas the progression II corresponds to the current through photodetector 10, at which the photodetector 10 is additionally irradiated. The progression II thus comprises the additional components of the photocurrent which leads to a displacement of the progression I.

The two progressions I and II show the previously mentioned behaviour of the photodetector 10 as an ohmic resistor, i.e. in the represented low bias voltage range, the two progressions I and II have an essentially linear behaviour between the bias voltage and the corresponding current strength of the “quasi”-signals.

The progression III corresponds to the difference between the progressions II and I and thus to the pure photocurrent, excluding the portion attributable to the temperature-dependent (reverse) current. As is apparent, the pure photocurrent is essentially not dependent on an applied low bias voltage and thus runs horizontally in dependence of the bias voltage. Studies have shown that this dependency is extremely low, for example, at 0.005%/mV of the bias voltage. As a reference, the progression IV also shows purely by way of example the difference between the progressions I and II (and consequently the inverse of the progression III) which is accordingly likewise not essentially dependent on the bias voltage.

The actual photocurrent, i.e. the current generated due to the irradiation of the photodetector 10, can thus be determined, for example, by a simple difference between the determined second output voltage and the determined first output voltage. The photocurrent measurement can thus also be performed despite the applied, low bias voltage, so that, in contrast to the prior art disclosed in EP 3 581 898 A1, it is not necessary to change the measurement modes between the two method steps S2 and S3. In this case, in particular, the voltage applied at the bias voltage connection 50 can remain unchanged during both measuring processes.

In practice, the second method step S2 and the third method step S3 can be performed one after the other within less than two seconds, in particular less than one second, for example 0.6 seconds. It is therefore made possible to assume that in this short time no sudden temperature change falsifies the determination results.

In order to determine the photocurrent or an output voltage dependent merely on the photocurrent, the method 200 can also comprise determining a difference between the second output voltage and the first output voltage. The difference can, for example, depend linearly and/or proportionally on a photocurrent of the photodetector 10 and/or a radiation intensity detected by the photodetector 10.

If the method 200 is performed by means of the optical gas sensor 100, a gas content, for example a gas concentration, can be determined within the measuring cell 110 from the difference between the second output voltage and first output voltage. If the gas to be measured is carbon dioxide, an infrared radiation source in particular can be used as a radiation source 120, since carbon dioxide absorbs at least a portion of the infrared radiation for specific wave lengths, in particular in the middle infrared region. In dependence on the gas concentration, more or less infrared radiation reaches the photodetector 10, so that accordingly also a higher or lower photocurrent is generated. The difference between the second output voltage and the first output voltage can therefore be used to determine the gas concentration.

With respect to determining or measuring the output voltages, the electronic arrangement 1 can comprise a current and/or voltage measuring device, for example an analogue-to-digital converter (ADC). Special attention can be paid here to an ADC range, for example a voltage range up to 2.8 V, i.e. a range that can be digitized by the analogue-to-digital converter.

Due to the characteristics of the photodetector 10, especially if it is a semiconductor-based infrared detector (for example, InSb or InAsSb), the temperature-dependent (reverse) current and thus the (reverse) current level increase as the temperature rises. At the same time, however, the photocurrent and thus the voltage level in the irradiated state also decrease, since the photosensitivity decreases with the rising temperature.

Thus, FIG. 7 shows exemplary progressions of the output voltages U in dependence on the temperature T. The progression I corresponds to the first output voltage, which increases with the rising temperature.

The progression II corresponds to the portion of the second output voltage which is solely attributable to the photocurrent. As is apparent, this reduces in contrast to the first output voltage, which is dependent solely on the (reverse) current, with the rising temperature. This leads to the fact that the total second output voltage, represented by the progression III and resulting from the sum of the two progressions I and II, also increases with the rising temperature, as does the progression I, but to a much lesser extent.

As a result, it is achieved that the output voltage remains within the relevant temperature range in a voltage range (for example up to 2.8 V), which can be digitized by the appropriate analogue-to-digital converter. It is thus provided, for example, by appropriately selecting the components of the electronic arrangement 1 to optimally utilize a specified ADC range.

The present disclosure is not limited to the above-described preferred exemplary embodiments. On the contrary, a multiplicity of variants and modifications are provided, which also make use of the disclosed concepts and therefore fall within the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

1 Electronic arrangement
10 Photodetector
11 Anode connection of the photodetector
12 Cathode connection of the photodetector
20 Operational amplifier
21 First input of the operational amplifier
22 Second input of the operational amplifier
23 Output of the operational amplifier
30 Voltage divider
31 Input of the voltage divider
32 First output of the voltage divider
33 Second output of the voltage divider
41 First path
42 Second path
43 Negative feedback path
44 Branch path
45 Region in the negative feedback path
50 Bias voltage connection
60 Earth connection
100 Optical gas sensor
110 Measuring cell
120 Radiation source
200 Method
C Capacitor
R1-R5 Resistors
S1-S3 Method steps

1. An electronic arrangement for determining a photocurrent taking into account a temperature dependence, comprising:
a photodetector which has an anode connection and a cathode connection;
an operational amplifier, which has a first input, a second input and an output, wherein the anode connection of the photodetector and the first input of the operational amplifier are electrically connected to one another, and the cathode connection of the photodetector and the second input of the operational amplifier are electrically connected to one another;
a bias voltage connection, which is electrically connected to the anode connection of the photodetector and the first input of the operational amplifier via a first path; and
a voltage divider, which is arranged within the first path between the anode connection of the photodetector and the bias voltage connection.

2. The electronic arrangement according to claim 1, wherein the voltage divider is configured to provide a bias voltage of the photodetector based on a voltage being applied at the bias voltage connection, the bias voltage:
having a value of 2 mV or less, and/or
being at least 100 times lower than the voltage applied at the bias voltage connection.

3. The electronic arrangement according to claim 1, wherein the bias voltage connection is also electrically connected to the cathode connection of the photodetector and the second input of the operational amplifier.

4. The electronic arrangement according to claim 1, wherein the second input of the operational amplifier is configured as an inverting input of the operational amplifier and/or the operational amplifier is configured as a part of a transimpedance amplifier.

5. The electronic arrangement according to claim 1, further comprising:
a negative feedback path, which electrically connects the second input of the operational amplifier and the output of the operational amplifier to one another, wherein the negative feedback path has two resistors connected in series.

6. The electronic arrangement according to claim 5, further comprising:
a branch path, which electrically connects the negative feedback path in a region between the two resistors connected in series and the bias voltage connection to one another, and wherein the branch path has a branch resistor.

7. The electronic arrangement according to claim 5, further comprising:
a capacitor, which is arranged parallel to the two resistors connected in series of the negative feedback path, to form a low-pass filter.

8. The electronic arrangement according to claim 1, wherein the voltage divider has an input, a first output and a second output, wherein the input of the voltage divider is electrically connected to the bias voltage connection and the first output of the voltage divider is electrically connected to the anode connection of the photodetector, and wherein the voltage provided at the first output of the voltage divider is at least 100 times lower than the voltage applied at the input of the voltage divider.

9. The electronic arrangement according to claim 8, wherein the voltage divider has a first resistor and a second resistor, wherein the first resistor is arranged between the input of the voltage divider and the first output of the voltage divider and wherein the first resistor and the second resistor are arranged between the input of the voltage divider and the second output of the voltage divider.

10. The electronic arrangement according to claim 1, further comprising:
an earth connection which is electrically connected to the anode connection of the photodetector and the bias voltage connection, and wherein the second output of the voltage divider is electrically connected to the earth connection.

11. The electronic arrangement according to claim 1, wherein an output voltage is configured to be determined and/or tapped between the output of the operational amplifier and the bias voltage connection in dependence upon a current applied at the photodetector.

12. The electronic arrangement according to claim 1, wherein the photodetector is a photodiode.

13. An optical gas sensor, comprising:
a measuring cell for receiving a gas;
a radiation source for emitting radiation in a direction of the measuring cell; and
the electronic arrangement according to claim 1, wherein the photodetector of the electronic arrangement is arranged to detect at least part of the radiation emitted by the radiation source that has passed through the measuring cell.

14. A method for determining a photocurrent taking into account a temperature dependence, wherein the method is performed by the electronic arrangement according to claim 1, the method comprising:
providing a bias voltage of the photodetector by applying a voltage at the bias voltage connection;
determining a first output voltage of the electronic arrangement and/or an optical gas sensor when a bias voltage is applied, wherein the photodetector is not irradiated by radiation and/or a radiation source for emitting radiation is deactivated; and
determining a second output voltage of the electronic arrangement and/or the optical gas sensor when a bias voltage is applied, wherein the photodetector is irradiated by radiation and/or the radiation source is activated.

15. The method according to claim 14, wherein the method is performed by the optical gas sensor, and wherein a gas content within a measuring cell of the optical gas sensor is determined from a difference between the second output voltage and the first output voltage.

16. The electronic arrangement according to claim 2, wherein the bias voltage:
has a value of 1 mV or less, and/or
is at least 200 times lower than the voltage applied at the bias voltage connection.

17. A method for determining a photocurrent taking into account a temperature dependence, wherein the method is performed by the optical gas sensor according to claim 13, the method comprising:
providing a bias voltage of the photodetector by applying a voltage at the bias voltage connection;
determining a first output voltage of the electronic arrangement and/or the optical gas sensor when a bias voltage is applied, wherein the photodetector is not irradiated by radiation and/or the radiation source for emitting radiation is deactivated; and
determining a second output voltage of the electronic arrangement and/or the optical gas sensor when a bias voltage is applied, wherein the photodetector is irradiated by radiation and/or the radiation source is activated.

18. The method according to claim 17, wherein a gas content within the measuring cell of the optical gas sensor is determined from a difference between the second output voltage and the first output voltage.
